(19) United States
(12) Patent Application Publication
(10) Pub. No.: US 2021/0213686 A1
(43) Pub. Date: Jul. 15, 2021

(54) STRENGTH PREDICTION METHOD AND STORAGE MEDIUM

(71) Applicant: TOYOTA JIDOSHA KABUSHIKI KAISHA, Toyota-shi (JP)

(72) Inventor: Yu YAMAMOTO, Toyota-shi (JP)

(73) Assignee: TOYOTA JIDOSHA KABUSHIKI KAISHA, Toyota-shi (JP)

(21) Appl. No.: 17/109,279

(22) Filed: Dec. 2, 2020

(30) Foreign Application Priority Data
Jan. 14, 2020 (JP) 2020-003636

(51) Int. Cl. B29C 64/393; B29C 64/307; B29C 64/153; B33Y 10/00

(52) U.S. Cl. CPC B29C 64/393; B33Y 10/00; B29C 64/153; B29C 64/307

(57) ABSTRACT

A strength prediction method for predicting strength of a structure that is additively manufactured using a 3D printer includes, in the additive manufacturing of the structure, predicting strength of a first layer of the structure in view of a first heat input that is applied when forming the first layer and a second heat input that is applied to the first layer when forming a second layer on the first layer.

### CROSS-REFERENCE TO RELATED APPLICATION

This application claims priority to Japanese Patent Application No. 2020-003636 filed on Jan. 14, 2019, incorporated herein by reference in its entirety.

### BACKGROUND

### 1. Technical Field

The disclosure relates to strength prediction methods and storage media.

### 2. Description of Related Art

A technique of analyzing the strength of a structure that is additively manufactured using a three-dimensional (3D) printer has been under development. Japanese Unexamined Patent Application Publication (Translation of PCT Application) No. 2018-518394 (JP 2018-518394 A) discloses a technique of, when additively manufacturing a structure using the 3D printer, comparing the thermal history of a master model with the thermal history obtained from images actually captured during manufacturing and evaluating the quality of a part according to the difference between the thermal histories.

### SUMMARY

However, the technique disclosed in JP 2018-518394 A cannot accurately predict the strength of the structure additively manufactured using the 3D printer.

The disclosure provides a strength prediction method capable of accurately predicting the strength of a structure that is additively manufactured using the 3D printer.

A strength prediction method for predicting strength of a structure that is additively manufactured using a 3D printer according to a first aspect of the disclosure includes: predicting, in an additive manufacturing of the structure, strength of a first layer of the structure in view of a first heat input that is applied when forming the first layer and a second heat input that is applied to the first layer when forming a second layer on the first layer.

According to the first aspect, the strength of the first layer is predicted in view of the first heat input that is applied when forming the first layer and the second heat input that is applied to the first layer when forming the second layer on the first layer. Since the second heat input is considered in addition to the first heat input, the influence that is exerted on the first layer during formation of the second layer is also reflected in the prediction. The strength of the structure can therefore be accurately predicted.

In the first aspect, the second heat input may be calculated based on a length of a period during which a temperature of the first layer is equal to or higher than a predetermined temperature and is lower than a melting temperature of a raw material of the structure. According to this configuration, the strength of the first layer can be accurately predicted by calculating the second heat input in view of the amount of heat that is applied in a period during which the strength of the first layer is affected (that is, the period during which the temperature of the first layer is equal to or higher than the predetermined temperature and is lower than the melting temperature of the structure) out of a period during which the second layer is formed.

In the above aspect, the second heat input may be calculated in view of a temperature change in the period. According to the above configuration, the second heat input can be more accurately calculated.

In a non-transitory storage medium storing instructions that are executable by one or more processors and that cause the one or more processors to perform functions according to a second aspect of the disclosure, the functions include: predicting, in additive manufacturing of a structure using a 3D printer, strength of a first layer of the structure in view of a first heat input that is applied when forming the first layer and a second heat input that is applied to the first layer when forming a second layer on the first layer.

In the second aspect, the second heat input may be calculated based on a length of a period during which a temperature of the first layer is equal to or higher than a predetermined temperature and is lower than a melting temperature of a raw material of the structure.

In the above aspect, the second heat input may be calculated in view of a temperature change in the period.

In the above aspect, the predetermined temperature may be set by a user.

The predetermined temperature needs to be determined experimentally in view of precipitation temperatures of elements contained in the structure, the relationship between grain size and temperature, etc. According to the above configuration, since the predetermined temperature can be set by the user, convenience is improved.

According to each aspect of the disclosure, the strength of the structure that is additively manufactured using a 3D printer can be accurately predicted.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view illustrating an example of the configuration of a 3D printer that is used for additive manufacturing of a structure;

FIG. 2 is a flowchart illustrating a series of steps from manufacturing to shipping of the structure;

FIG. 3 is a schematic view illustrating the influence that is exerted on a certain layer when forming another layer on the certain layer during additive manufacturing of the structure in step S102 of FIG. 2;

FIG. 4 is a schematic view illustrating the influence that is exerted on a certain layer when forming another layer on the certain layer during additive manufacturing of the structure in step S102 of FIG. 2;

FIG. 5 is a schematic view illustrating the outer shape of a structure actually additively manufactured using the 3D printer;

FIG. 6 is a graph illustrating the measurement results of the hardness of the structure actually additively manufactured using the 3D printer;

FIG. 7 is a flowchart illustrating a flow of a strength prediction method for predicting the strength of a structure that is additively manufactured using the 3D printer according to an embodiment; and

FIG. 8 is a graph schematically illustrating calculation of a first heat input in step S203 of FIG. 7 and calculation of a second heat input in step S204 of FIG. 7.

### DETAILED DESCRIPTION OF EMBODIMENTS

The disclosure will be described by means of an embodiment of the disclosure. However, the disclosure according to claims is not limited to the following embodiment. Not all of the configurations described in the embodiment are necessarily essential as solutions to the issue. For clarity of explanation, the following description and drawings are omitted or simplified as appropriate. The same elements are denoted with the same signs throughout the drawings, and repeated description thereof is omitted as needed.

Before describing a strength prediction method for predicting the strength of a structure that is additively manufactured using a 3D printer according to the embodiment, the configuration of the 3D printer that is used to additively manufacturing a structure and a method for additively manufacturing a structure using the 3D printer will be described. In the example described below, the additive manufacturing method is selective laser melting (SLM).

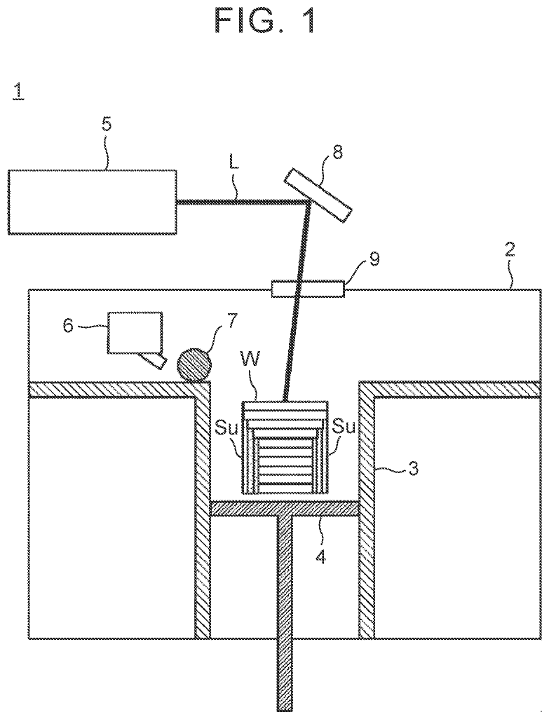

First, the configuration of the 3D printer that is used to additively manufacture a structure will be described. FIG. 1 is a schematic view illustrating an example of the configuration of the 3D printer that is used to additively manufacturing a structure. As shown in FIG. 1, a 3D printer 1 includes a chamber 2, a build tank 3, a base plate 4, a laser light source 5, a powder supply unit 6, a recoater 7, and a beam scanning mechanism 8.

The base plate 4 is a plate material that serves as a base for a structure W. The base plate 4 is disposed so as to be movable vertically within the build tank 3. The powder supply unit 6 that supplies metal powder is disposed above the build tank 3. The metal powder is, for example, aluminum alloy powder or titanium alloy powder. The recoater 7 spreads a layer of metal powder supplied from the powder supply unit 6, over the base plate 4. The build tank 3, the base plate 4, the powder supply unit 6, and the recoater 7 are accommodated in the chamber 2. An inert gas such as nitrogen gas or argon gas may be introduced into the chamber 2. The chamber 2 may be evacuated.

The laser light source 5 is a light source for emitting a laser beam L. The beam scanning mechanism 8 is a mechanism for steering the laser beam L to a predetermined position on the metal powder. The beam scanning mechanism 8 is, for example, a galvanometer mirror. The laser light source 5 and the beam scanning mechanism 8 are disposed outside the chamber 2. The laser beam L enters the chamber 2 through a light transmitting portion 9 of the chamber 2.

Next, the method for additively manufacturing a structure using the 3D printer will be described with reference to FIG. 1. In additive manufacturing, the beam scanning mechanism 8 steers the laser beam L to a predetermined part of the metal powder to melt and cure this part of the metal powder. After one layer is formed, the metal powder is further supplied by the powder supply unit 6 and spread over the layer by the recoater 7. A predetermined part of this metal powder is then melted and cured by the laser beam L to form the next layer. The thickness of each layer is, for example, 50 μm. A desired structure is thus formed by repeatedly spreading the metal powder over the previous layer and melting and curing the metal powder. In metal additive manufacturing, a support member Su that supports an overhanging portion is typically added in order to prevent sagging.

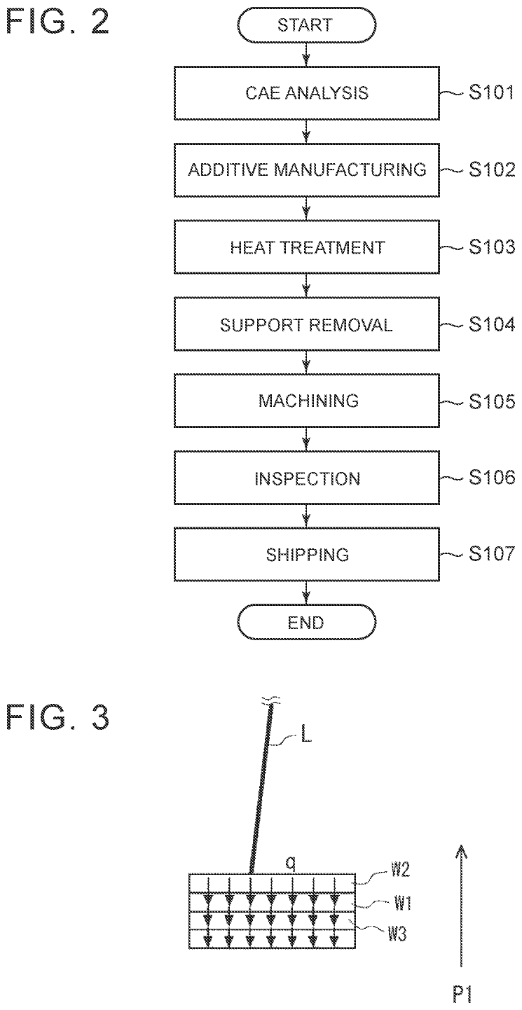

Next, a series of steps from manufacturing to shipping of a structure will be described. FIG. 2 is a flowchart illustrating the series of steps from manufacturing to shipping of a structure. As shown in FIG. 2, CAE analysis is first performed using CAD data on a building model to be built and analysis conditions as input data (step S101). The CAE analysis is performed using common CAE software capable of performing calculations such as structural analysis, calculation of strength (stress and deformation), calculation of natural frequency, and topology optimization. Specifically, the strength prediction method for predicting the strength of a structure that is additively manufactured using the 3D printer according to the embodiment, which will be described later, is applied to the common CAE software, and the CAE analysis is performed using this CAE software.

Thereafter, a structure is additively manufactured (step S102). In addition to the selective laser melting (SLM) described above, various additive manufacturing (AM) techniques such as electron beam melting (EBM) can be used in the additive manufacturing step.

The structure built in step S102 then undergoes heat treatment (step S103). The heat treatment is typically performed in order to remove distortion caused during building of the structure and to provide sufficient strength properties. The heat treatment does not require any special furnace, and a common batch or continuous furnace can be used. The structure is sometimes shipped as a product without being heat treated.

Subsequently, the support for the structure is removed (step S104). As described above, in metal additive manufacturing, a support member is typically added to an overhang portion. However, since such a support member is not necessary for a final structure, the support member is removed using needle nose-pliers etc. The structure is then machined as required according to the product (step S105). The structure is thus completed. Thereafter, the completed structure is inspected (step S106). The inspection of the structure includes visual inspection by X-ray CT, dimensional measurement using a coordinate measuring machine, etc. The inspected product is then shipped (step S107).

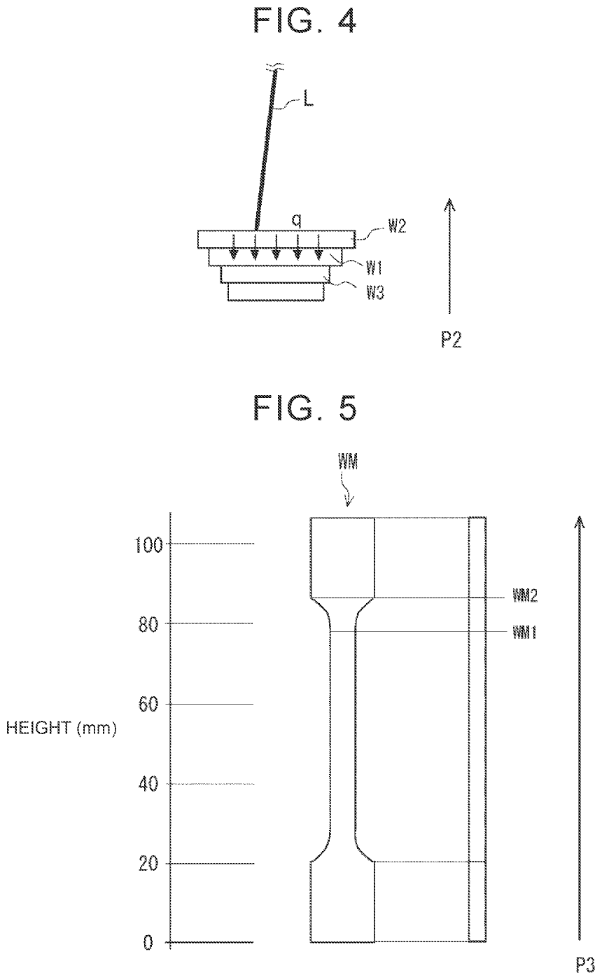

Next, the influence that is exerted on a certain layer when forming another layer on the certain layer during additive manufacturing of the structure in step S102 of FIG. 2 will be described. FIGS. 3 and 4 are schematic views illustrating the influence that is exerted on a certain layer when forming another layer on the certain layer during additive manufacturing of the structure in step S102 of FIG. 2. Arrows q in FIGS. 3 and 4 represent the flow of heat. Arrow P1 in FIG. 3 and arrow P2 in FIG. 4 represent the stacking direction of layers in the structure. As shown in FIG. 3, when forming another layer (second layer W2) on a certain layer (first layer W1) of the structure being built, a part of metal powder that corresponds to the second layer W2 is melted by the laser beam L etc. Heat is generated as this part of the metal powder is melted. This heat is transmitted to the first layer W1. In the case where the sectional area of a layer (third layer W3) under the first layer W1 is about the same as that of the first layer W1, the heat generated during formation of the second layer W2 is transmitted from the first layer W1 to the third layer W3 and further diffuses from the third layer W3 to a layer under the third layer W3.

However, as shown in FIG. 4, in the case where the sectional area of the layer (third layer W3) under the first layer W1 is considerably smaller than that of the first layer W1, the heat generated during formation of the second layer W2 is less likely to diffuse from the first layer W1 to the layers under the first layer W1. During formation of the second layer W2, the first layer W1 is therefore overaged by the heat transmitted from the second layer W2. As a result, the strength, such as hardness, of the first layer W1 is reduced.

FIG. 5 is a schematic view illustrating the outer shape of a structure WM actually additively manufactured using the 3D printer. Arrow P3 in FIG. 5 represents the stacking direction. As shown in FIG. 5, the sectional area of the structure WM changes considerably between a position WM1 and a position WM2. That is, the sectional area of the structure WM decreases from an upper layer toward a lower layer between the position WM1 and the position WM2. The structure WM was built by SLM, and the metal powder used was AlSi10Mg alloy powder with a particle size of about 100 μm or less.

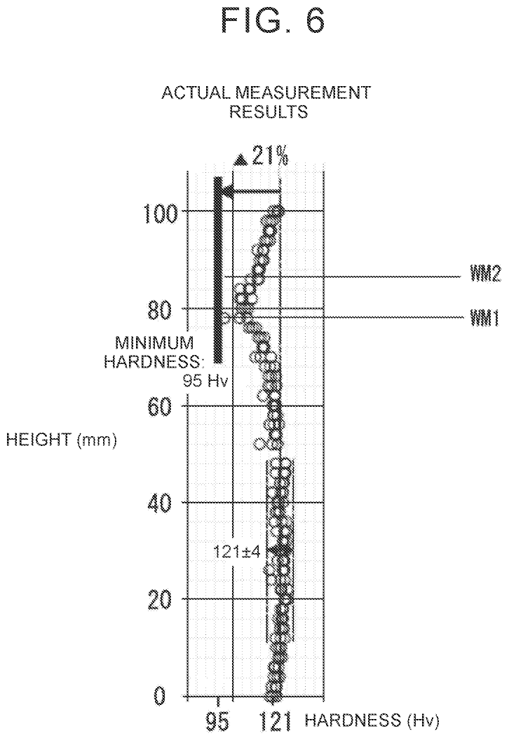

FIG. 6 illustrates the measurement results of the hardness of the structure WM actually additively manufactured using the 3D printer. In this example, the hardness is Vickers hardness, and the measurement was performed by the method specified by JIS standards. As shown in FIG. 6, the hardness of the structure WM decreases between the position WM1 and the position WM2. The reason for such a decrease in hardness is considered as follows. Since the sectional area of a model of the structure WM decreases from an upper layer toward a lower layer between the position WM1 and the position WM2, heat generated during formation of the upper layer did not diffuse, and a layer immediately under the upper layer was overaged by the heat. As a result, the strength of the layer immediately under the upper layer was reduced.

Next, the strength prediction method for predicting the strength of a structure that is additively manufactured using the 3D printer according to the embodiment will be described.

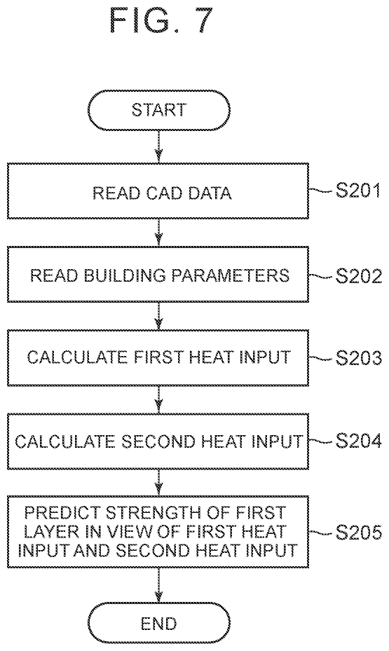

FIG. 7 is a flowchart illustrating the strength prediction method for predicting the strength of a structure that is additively manufactured using the 3D printer according to the embodiment. As shown in FIG. 7, CAD data on a building model to be built is first read (step S201). Various building parameters such as physical properties of a raw material to be used and laser output are then read (step S202).

After step S202, a heat input (first heat input) that is applied when forming a first layer is calculated (step S203). The first heat input is the amount of heat that is applied by a laser etc. when forming the first layer. Thereafter, the amount of heat (second heat input) that is applied to the first layer when forming a second layer on the first layer is calculated (step S204). When calculating the second heat input in step S204, all of the layers to be stacked on the first layer may be considered to be the second layers, or the layer immediately above the first layer to the layer located a predetermined number of layers above the layer immediately above the first layer may be considered to be the second layers. How many layers above the first layer are to be considered to calculate the second heat input can be determined experimentally. In the case where the layer immediately above the first layer to the layer located the predetermined number of layers above the layer immediately above the first layer are considered to be the second layers, the second heat input can be calculated with a reduced calculation load as compared to the case where all of the layers to be stacked on the first layer are considered to be the second layers. Subsequently, in additive manufacturing of the structure, the strength of the first layer is predicted in view of the first heat input and the second heat input (step S205).

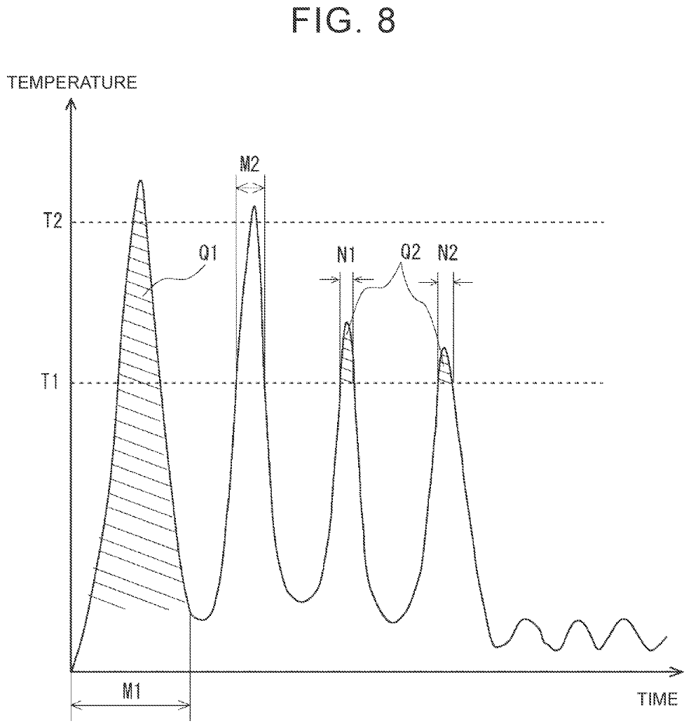

FIG. 8 is a graph schematically illustrating the calculation of the first heat input in step S203 and the calculation of the second heat input in step S204 of FIG. 7. The graph of FIG. 8 illustrates the thermal history of the first layer in the structure, where the abscissa represents time and the ordinate represents temperature. The thermal history of the first layer in the structure can be derived using a common thermal analysis simulation. In FIG. 8, T1 represents a predetermined temperature and T2 represents a melting temperature of the raw material of the structure. The predetermined temperature T1 is experimentally determined in view of the precipitation temperatures of elements contained in the structure, the relationship between grain size and temperature, etc.

As shown in FIG. 8, a period M1 is a period during which the first layer is formed by a laser etc., when forming the first layer. Periods N1, N2 are periods during which the temperature of the first layer is equal to or higher than the predetermined temperature T1 and is lower than the melting temperature T2 of the raw material of the structure when forming the second layer above the first layer. That is, the amount of heat Q1 that is applied to the first layer in the period M1 is the first heat input that is calculated in step S203 of FIG. 7, and the amount of heat Q2 that increases the temperature of the first layer to T1 or higher in the periods N1, N2 is the second heat input that is calculated in step S204 of FIG. 7. The first heat input and the second heat input can be calculated by integration of time and temperature in the thermal history of the first layer. Specifically, the amount of heat is obtained by multiplying the integration value by the weight of the first layer and the specific heat of the first layer.

When the temperature of the first layer increases to the melting temperature T2 of the raw material of the structure or higher during formation of a layer above the first layer (in the case of a period M2 in FIG. 8), the first layer is not aged but is remelted. In the case where the temperature of the first layer increases to the melting temperature T2 of the raw material of the structure or higher and the first layer is remelted, the strength of the first layer is approximately the same as the original strength of the first layer. Accordingly, the amount of heat in the period M2 is not considered in calculation of the second heat input. The second heat input is calculated as the total amount of heat in the period during which the temperature of the first layer is equal to or higher than the predetermined temperature T1 and is lower than the melting temperature T2 of the raw material of the structure. That is, the second heat input may be calculated in view of a temperature change in the period during which the temperature of the first layer is equal to or higher than the predetermined temperature T1 and is lower than the melting temperature T2 of the raw material of the structure.

However, the second heat input may be calculated based only on the length of the period during which the temperature of the first layer is equal to or higher than the predetermined temperature and is lower than the melting temperature T2 of the raw material of the structure, without considering a temperature change in this period. That is, the second heat input is approximately calculated on the assumption that the temperature of the first layer is always constant in the period during which the temperature of the first layer is equal to or higher than the predetermined temperature and is lower than the melting temperature T2 of the raw material of the structure. In this case, the calculated second heat input is slightly less accurate than in the case where the second heat input is calculated by integration of time and temperature in the period during which the temperature of the first layer is equal to or higher than the predetermined temperature and is lower than the melting temperature T2 of the raw material of the structure. However, the calculation load is reduced.

As described above, in the strength prediction method according to the embodiment, the strength of the first layer is predicted in view of the first heat input that is applied when forming the first layer and the second heat input that is applied to the first layer when forming the second layer on the first layer. Since the second heat input is considered in addition to the first heat input, the influence that is exerted on the first layer during formation of the second layer is also reflected in the prediction. The strength of the structure can therefore be accurately predicted. Since the strength of the structure can be accurately predicted, whether the stacking direction of the structure is appropriate can be determined. For example, for the structure WM shown in FIG. 5, arrow P3 represents the stacking direction. For this structure WM, it is predicted that the strength of the structure WM is insufficient between the position WM1 and the position WM2. It is therefore concluded that the stacking direction of the structure WM should be changed.

The disclosure is not limited to the above embodiment and can be modified as appropriate without departing from the spirit and scope of the disclosure.

Each process in the strength prediction method of the above embodiment can also be implemented by, for example, causing a computer to execute a program. More specifically, each process in the strength prediction method of the above embodiment can also be implemented by loading a control program stored in a storage unit (not shown) into a main storage device (not shown) of the computer and executing the program in the main storage device.

In the case where each process in the strength prediction method of the above embodiment is also implemented by causing a computer to execute a program, the program may be designed such that the predetermined temperature can be set by a user. The predetermined temperature needs to be determined experimentally in view of the precipitation temperatures of the elements contained in the structure, the relationship between grain size and temperature, etc. Since the predetermined temperature can be set by the user, convenience is improved.

The program can be stored and supplied to the computer by using various types of non-transitory computer-readable media. The non-transitory computer-readable media include various types of tangible storage media. Examples of the non-transitory computer-readable media include magnetic recording media (e.g., a flexible disk, a magnetic tape, and a hard disk drive), magnetooptical recording media (e.g., a magnetooptical disk), a CD read-only memory (CD-ROM), a compact disc-recordable (CD-R), a compact disc-rewritable (CD-R/W), and semiconductor memories (e.g., a mask ROM, a programmable ROM (PROM), an erasable PROM (EPROM), a flash ROM, and a random access memory (RAM)). The program may be supplied to the computer by using various types of transitory computer-readable media. Examples of the transitory computer-readable media include electrical signals, optical signals, and electromagnetic waves. The transitory computer-readable medium can supply the program to the computer via either a wired communication path such as an electrical wire or an optical fiber or a wireless communication path.

What is claimed is:

1. A strength prediction method for predicting strength of a structure that is additively manufactured using a 3D printer, comprising:
predicting, in an additive manufacturing of the structure, strength of a first layer of the structure in view of a first heat input that is applied when forming the first layer and a second heat input that is applied to the first layer when forming a second layer on the first layer.

2. The strength prediction method according to claim 1, wherein the second heat input is calculated based on a length of a period during which a temperature of the first layer is equal to or higher than a predetermined temperature and is lower than a melting temperature of a raw material of the structure.

3. The strength prediction method according to claim 2, wherein the second heat input is calculated in view of a temperature change in the period.

4. A non-transitory storage medium storing instructions that are executable by one or more processors and that cause the one or more processors to perform functions comprising:
predicting, in additive manufacturing of a structure using a 3D printer, strength of a first layer of the structure in view of a first heat input that is applied when forming the first layer and a second heat input that is applied to the first layer when forming a second layer on the first layer.

5. The storage medium according to claim 4, wherein the second heat input is calculated based on a length of a period during which a temperature of the first layer is equal to or higher than a predetermined temperature and is lower than a melting temperature of a raw material of the structure.

6. The storage medium according to claim 5, wherein the second heat input is calculated in view of a temperature change in the period.

7. The storage medium according to claim 5, wherein the predetermined temperature is set by a user.

8. The storage medium according to claim 6, wherein the predetermined temperature is set by a user.
